(19) United States
(12) Patent Application Publication
(10) Pub. No.: US 2023/0151760 A1
(43) Pub. Date: May 18, 2023

(54) CONTROL METHOD FOR AN ENGINE COOLANT VALVE

(71) Applicants: HYUNDAI MOTOR COMPANY, Seoul (KR); KIA CORPORATION, Seoul (KR)

(72) Inventors: Dusung Moon, Seoul (KR); In Kyun Lee, Seongnam-si (KR); Young Seop Kwon, Seoul (KR)

(73) Assignees: HYUNDAI MOTOR COMPANY, Seoul (KR); KIA CORPORATION, Seoul (KR)

(21) Appl. No.: 17/984,663

(22) Filed: Nov. 10, 2022

(30) Foreign Application Priority Data
Nov. 15, 2021 (KR) 10-2021-0156603

(51) Int. Cl. F01P 11/16; F01P 11/02

(52) U.S. Cl. CPC F01P 11/16; F01P 11/0276; F01P 2031/20; F01P 2007/146

(57) ABSTRACT

A control method for an engine coolant valve includes: monitoring an engine driving condition and an engine driving environment; predicting, by a controller, degradation of an engine coolant based on the engine driving condition and the engine driving environment by a controller; changing, by the controller, an opening of an integrated flow control valve when the engine coolant is predicted to be degraded; and generating, by the controller, a coolant exchange alarm when the engine coolant is predicted to be out of a control range and degraded.

### CROSS-REFERENCE TO RELATED APPLICATION

This application claims priority to and the benefit of Korean Patent Application No. 10-2021-0156603, filed in the Korean Intellectual Property Office on Nov. 15, 2021, the entire contents of which are incorporated herein by reference.

### BACKGROUND

### (a) Field

The present disclosure relates to a control method for an engine coolant valve. More particularly, the present disclosure relates to prediction of engine coolant degradation and a control method of an engine coolant valve accordingly.

### (b) Description of the Related Art

In general, a temperature of a vehicle engine increases due to operation heat after starting the engine. Thus, a coolant for cooling the engine circulates along a coolant circulation line (e.g., a water jacket) of the engine.

When the temperature of the coolant circulating in the coolant circulation line inside the engine is above a certain temperature, a thermostat (a water temperature controller) opens and the coolant at such a high temperature flows into the radiator. Then, the coolant in the radiator is cooled by heat-exchange with the outside air. The cooled coolant exited from the radiator is recirculated to the coolant circulation line formed in the engine block of the engine and the coolant circulation line formed in the cylinder head.

However, when the engine coolant is exposed to high temperature for a long time, a corrosion resistance performance deteriorates due to a reduction of a phosphorus (P) component, and then engine parts (e.g., an Exhaust Gas Recirculation “EGR” cooler, an oil cooler, the radiator, etc.) of the coolant circulation path are corroded. The coolant loss caused by the corrosion of the engine parts causes an engine bearing/piston/crank train seizure due to engine overheating and deterioration of a lubrication system performance, thereby causing a serious engine failure (a total failure).

The above information disclosed in this Background section is provided only to enhance understanding of the background of the present disclosure. Thus, it may contain information that does not form the prior art that is already known to a person of ordinary skill in the art.

### SUMMARY

The present disclosure provides a control method of an engine coolant valve that may prevent additional coolant degradation (prevention of a reduction of the phosphorus component due to a high temperature) by predicting the degradation of the engine coolant by using a predicted decrease of the phosphorus component (“P” component) in the modeled coolant depending on a high temperature exposure time of the engine coolant and a coolant maximum temperature inside the engine, and lowering an inlet/outlet temperature control value of an integrated flow control valve if it is determined that the coolant degradation has progressed due to the exposure to high temperature.

A control method of an engine coolant valve according to an embodiment of the present disclosure includes: monitoring an engine driving condition and an engine driving environment; predicting a degradation of an engine coolant based on the engine driving condition and the engine driving environment by a controller; changing a control temperature of an integrated flow control valve when the engine coolant is predicted to be degraded by the controller; and generating a coolant exchange alarm when the engine coolant is predicted to be out of the control range and degraded by the controller.

The engine driving condition and the engine driving environment may be an engine coolant temperature, an engine load, and an engine intake temperature.

The predicting of the degradation of the engine coolant may predict the degradation of the engine coolant by content data of phosphorus (P) in the coolant predetermined according to the engine coolant temperature and a high temperature exposure time of the engine coolant.

The engine coolant temperature may be measured by a temperature sensor provided on the engine outlet.

The predicting of the degradation of the engine coolant may predict the engine coolant to be degraded if the content of phosphorus in the coolant is predicted to be less than a first value.

The content of phosphorus in the coolant may be predicted by subtracting a reduction amount of the phosphorus component according to the engine coolant temperature from a phosphorus content of new coolant.

The reduction amount of the phosphorus component may be calculated by [Equation 1] below when the engine coolant temperature is measured as 90° C.

Y₁=−aX₁²+bX₁ [Equation 1]

Here, Y1 is the reduction amount of the phosphorus component, and X1 is the high temperature exposure time. Also, a is a constant greater than 0.0001 and less than 0.001, and b is a constant greater than 0 and less than 1.

The reduction amount of the phosphorus component may be calculated by [Equation 2] below when the engine coolant temperature is measured at 100° C.

Y₂=−cX₂²+dX₂ [Equation 2]

Here, Y2 is the reduction amount of the phosphorus component, and X2 is the high temperature exposure time. Also, c is a constant greater than 0.001 and less than 0.01, and d is a constant greater than 1 and less than 2.

The reduction amount of the phosphorus component may be calculated by [Equation 3] below when the engine coolant temperature is measured at 110° C.

Y₃=−eX₃²+fX₃ [Equation 3]

Here, Y3 is the reduction amount of the phosphorus component, and X3 is the high temperature exposure time. Also, e is a constant greater than 0.001 and less than 0.01, and f is a constant greater than 4 and less than 5.

The reduction amount of the phosphorus component may be calculated by [Equation 4] below when the engine coolant temperature is measured at 120° C.

Y₄=−gX₄⁴−hX₄³−iX₄²+jX₄ [Equation 4]

Here, Y4 is the reduction amount of the phosphorus component, and X4 is the high temperature exposure time. In addition, g is a constant greater than 0.00000001 and less than 0.000001, h is a constant greater than 0.00001 and less than 0.0001, i is a constant greater than 0.001 and less than 0.01, and j is a constant greater than 5 and less than 6.

The reduction amount of the phosphorus component may be calculated by [Equation 5] below when the engine coolant temperature is measured at 130° C.

Y₅=−kX₅⁴−lX₅³−mX₅² [Equation 5]

Here, Y5 is the reduction amount of the phosphorus component, and X5 is the high temperature exposure time. Also, k is a constant greater than 0.0000001 and less than 0.000001, l is a constant greater than 0.00001 and less than 0.0001, and m is a constant greater than 0.01 and less than 0.1.

The changing of the control temperature of the integrated flow control valve may include increasing an opening of the integrated flow control valve to lower the control temperature.

In the generating of the coolant exchange alarm, if the content of phosphorus in the coolant is predicted to be smaller than the second value, it may be predicted that the engine coolant is out of the control range and degraded, and the coolant exchange alarm is generated.

According to the present disclosure, the damage to the parts of the engine cooling system may be prevented in advance by managing the coolant quality through the degradation prediction of the engine coolant.

In addition, through the degradation prediction of the engine coolant, excessive maintenance is prevented and efficient coolant management is possible with an appropriate engine coolant exchange alarm.

In addition, through the degradation prediction of the engine coolant, it is possible to increase a lifespan of the engine and to strengthen commerciality and competitiveness by reducing the maintenance cost.

### BRIEF DESCRIPTION OF THE DRAWINGS

In order that the disclosure may be well understood, there will now be described various forms thereof, given by way of example, reference being made to the accompanying drawings, in which:

FIG. 1 is a view schematically showing an engine cooling system to which a control method of an engine coolant valve according to an embodiment of the present disclosure is applied;

FIG. 2 is a flowchart showing a control method of an engine coolant valve according to an embodiment of the present disclosure; and

FIG. 3 a graph showing content data of phosphorus (P) in a coolant predetermined according to an engine coolant temperature and a high temperature exposure time of an engine coolant, which is applied to a control method of an engine coolant valve according to an embodiment of the present disclosure.

The drawings described herein are for illustration purposes only and are not intended to limit the scope of the present disclosure in any way.

### DETAILED DESCRIPTION

Hereinafter, with reference to the accompanying drawings, embodiments of the present disclosure are described in detail so that a person of ordinary skill in the art to which the present disclosure pertains can easily implement the same. As those having ordinary skill in the art would realize, the described embodiments may be modified in various different ways, all without departing from the spirit or scope of the present disclosure.

Further, in the embodiments, since like reference numerals designate like elements having the same configuration, a first embodiment is representatively described, and in other embodiments, only configurations different from the first embodiment have been described below.

The drawings are schematic and are not illustrated in accordance with a scale. Relative dimensions and ratios of portions in the drawings are illustrated to be exaggerated or reduced in size for clarity and convenience, and the dimensions are just exemplified and are not limiting. In addition, like structures, elements, or components illustrated in two or more drawings use same reference numerals for showing similar features. It should be understood that when an element such as a layer, film, region, or substrate is referred to as being “on” another element, it can be directly on the other element or intervening elements may also be present.

The following description is merely exemplary in nature and is not intended to limit the present disclosure, application, or uses. Thus, various modifications of the embodiments illustrated in the drawings should be expected. Therefore, the embodiment is not limited to a specific aspect of the illustrated region, and for example, includes modifications of an aspect by manufacturing.

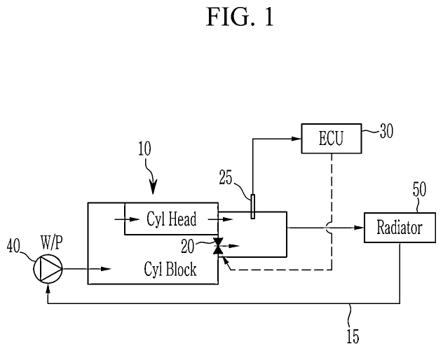

Hereinafter, a control method of an engine coolant valve according to an embodiment of the present disclosure is described with reference to FIG. 1 to FIG. 3.

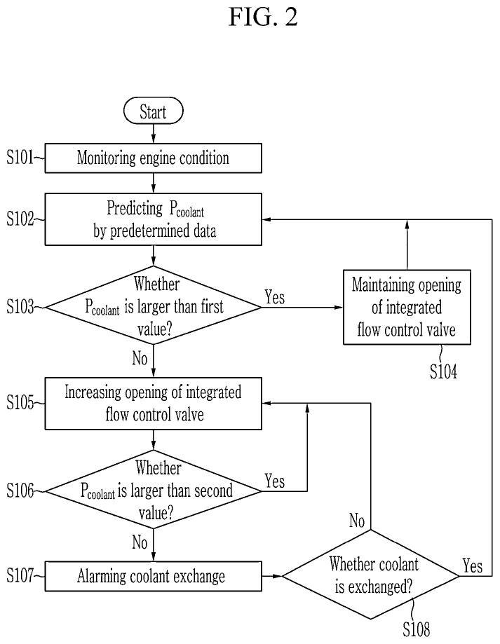

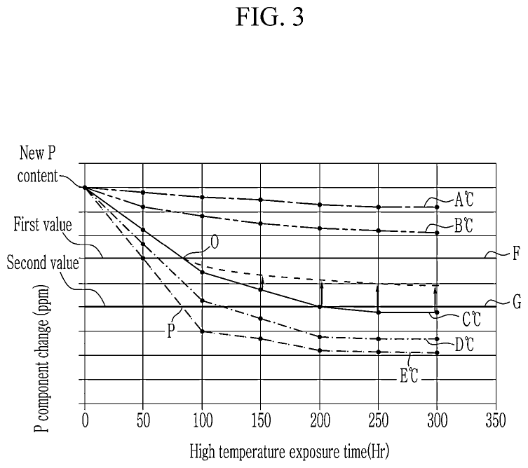

FIG. 1 is a view schematically showing an engine cooling system to which a control method of an engine coolant valve according to an embodiment of the present disclosure is applied, FIG. 2 is a flowchart showing a control method of an engine coolant valve according to an embodiment of the present disclosure, and FIG. 3 is a graph showing content data of phosphorus (P) in a coolant predetermined according to a temperature of the engine coolant and a high temperature exposure time of the engine coolant, which is applied to a control method of an engine coolant valve according to an embodiment of the present disclosure.

First, referring to FIG. 1, an engine 10 generates a torque to drive a vehicle, by fuel combustion, as well as heat energy to be exhausted. In the engine 10, an engine coolant circulates along a coolant line 15 formed in the engine 10, a radiator 50, and a coolant pump 40. During such circulation, the coolant absorbs the heat energy and discharges it to the outside. Such an engine cooling system may further include a heater, an EGR cooler, an oil cooler, and the like. In one embodiment, the engine cooling system may further include an integrated flow control valve 20. The integrated flow control valve 20 controls several cooling elements to maintain the temperature of the engine coolant at high in a specific operation region of the engine 10 and maintain it at low in other operation region.

The engine coolant at a high temperature (hereinafter “high-temperature engine coolant”) is cooled by exchanging heat with the outside air in the radiator 50. The coolant passes through a cylinder head (“Cyl Head” in FIG. 1) and a cylinder block (“Cyl Block” in FIG. 1) of the engine 10, and the flow rate of the engine coolant is regulated according to the opening of the integrated flow control valve 20. If the flow rate of the engine coolant is adjusted to increase, the temperature of the engine coolant is decreased. A temperature sensor 25 is installed at an outlet of the engine 10 outside the integrated flow control valve 20 so that the temperature of the engine coolant may be measured.

In an embodiment of the present disclosure, a control method of an engine coolant valve, which is applied to the engine cooling system as described above, may include: first monitoring a driving condition of the engine 10 and a driving environment of the engine 10 (S101). In one embodiment, the driving condition of the engine 10 and the driving environment of the engine 10 may include an engine coolant temperature, a load the engine 10, and an intake temperature of the engine 10. Particularly, the engine coolant temperature may be measured by the temperature sensor 25 provided at the outlet of the engine 10.

Next, the degradation of the engine coolant is predicted by the controller 30 based on the driving condition of the engine 10 and the driving environment of the engine 10 (S102). In particular, the controller 30 may predict the degradation of the engine coolant by the content data of phosphorus (P) in the coolant predetermined according to the engine coolant temperature and the high temperature exposure time of the engine coolant. In other words, the content data of phosphorus (P) in the coolant is obtained in advance through a test according to the temperature of the engine coolant and the period of time that the engine coolant is exposed to a high temperature.

In one form, the controller 300 may be implemented by one or more processors operating according to a set program, and the set program may be programmed to perform each step of the control method of the engine coolant valve according to an embodiment of the present disclosure.

As shown in FIG. 3, change data of the phosphorus component in the engine coolant according to the engine coolant temperature (e.g., from A ° C. to E ° C.) and the high temperature exposure time of the engine coolant may be obtained in advance through a thermal oxidation principle test. In this case, A may be 90 degrees Celsius (° C.), B may be 100° C., C may be 110° C., D may be 120° C., and E may be 130° C.

Referring to FIG. 3, it may be confirmed that the phosphorus components in the engine coolant with the temperature of A ° C. to E ° C. are all decreasing during the high temperature exposure time of the engine coolant (0 hours to 300 hours range). When the engine coolant temperature is A ° C. and B° C., the phosphorus component in the engine coolant is maintained above the first value. Here, the first value may be a value obtained in advance through the thermal oxidation principle test, which is smaller than an initial phosphorus content of a new coolant.

Also, when the engine coolant temperature is C ° C., it may be seen that when being exposed to a high temperature for about 80 hours, the phosphorus component in the engine coolant decreases below the first value (a point “0”), and when being exposed to a high temperature for about 200 hours, the phosphorus component in the engine coolant decreases below the second value. Here, the second value may be a value obtained in advance through the thermal oxidation principle test, which is smaller than the first value.

Also, when the engine coolant temperature is D ° C., it may be seen that the phosphorus component in the engine coolant decreases below the first value when being exposed to a high temperature for about 65 hours, and the phosphorus component in the engine coolant decreases below the second value when being exposed to a high temperature for about 120 hours.

Also, when the engine coolant temperature is E ° C., it may be seen that the phosphorus component in the engine coolant decreases below the first value when being exposed to a high temperature for about 50 hours, and the phosphorus component in the engine coolant decreases below the second value when being exposed to a high temperature for about 65 hours.

As such, because the time point at which the phosphorus content in the engine coolant decreases depends on the engine coolant temperature, it is desired to change the engine coolant temperature so that the phosphorus content in the engine coolant may be maintained high even after the high temperature exposure time of the engine coolant elapses.

In an embodiment of the present disclosure, the degradation of the coolant may be predicted through the change of the phosphorus component in the engine coolant according to the time when the new coolant is exposed to different temperatures.

By using the predetermined data shown in FIG. 3, when substituting the engine coolant temperature and the high temperature exposure time measured by the temperature sensor 25, it is predicted whether the content of phosphorus in the engine coolant is less than the first value (a line F), and if the content of phosphorus in the engine coolant is less than the first value, it is predicted that the engine coolant is degraded.

After that, if the engine coolant is predicted to be degraded, the control temperature is changed by the controller 30 by increasing the opening of the integrated flow control valve 20 (S103 and S105).

For example, in the predetermined data of FIG. 3, if the engine coolant temperature measured by the temperature sensor 25 is C ° C. and the high temperature exposure time is about 80 hours (a point “0”), the controller 30 predicts that the phosphorus content in the engine coolant is below the first value, and predicts that the engine coolant is degraded, thereby increasing the opening of the integrated flow control valve 20 to lower the engine coolant temperature. In other words, the control is performed by the controller 30 to raise the graph line by lowering the engine coolant temperature from C ° C.

Also, if the engine coolant temperature measured by the temperature sensor 25 is D ° C. and the high temperature exposure time is about 70 hours, the controller 30 predicts that the phosphorus content in the engine coolant is less than the first value, and predicts that the engine coolant is degraded. And, if the engine coolant temperature measured by the temperature sensor 25 is E° C. and the high temperature exposure time is about 50 hours, the controller 30 predicts that the phosphorus content in the engine coolant is less than the first value, and predicts that the engine coolant is degraded.

On the other hand, when the engine coolant temperature measured by the temperature sensor 25 is A° C. and B° C., according to the predetermined data, since the phosphorus content is predicted to be higher than the first value within the high temperature exposure time of 300 hours, the controller 30 maintains the opening of the integrated flow control valve 20 (S103 and S104).

After that, when the engine coolant is predicted to be degraded out of the control range by the controller 30, a coolant exchange alarm is generated (S106 and S107). At this time, if the content of phosphorus in the engine coolant is predicted to be smaller than the second value (a line G), the controller 30 predicts that the engine coolant is out of the control range and degraded.

For example, in the predetermined data of FIG. 3, if the engine coolant temperature measured by the temperature sensor 25 is C° C. and the high temperature exposure time is about 200 hours, the controller 30 predicts that the phosphorus content in the engine coolant is less than the second value and predicts that the engine coolant is out of the control range and degraded, and generates an engine coolant exchange alarm.

Also, if the engine coolant temperature measured by the temperature sensor 25 is D° C. and the high temperature exposure time is about 120 hours, the controller 30 predicts that the phosphorus content in the engine coolant is less than the second value and predicts that the engine coolant is out of the control range and degraded. Also, if the engine coolant temperature measured by the temperature sensor 25 is E° C. and the high temperature exposure time is about 60 hours (a point P), the controller 30 predicts that the phosphorus content in the engine coolant is less than the second value and predicts that the coolant is out of the control range and degraded.

After the engine coolant exchange alarm occurs, if it is determined that the engine coolant has been replaced, it is returned to predicting the degradation of the engine coolant by the predetermined data of the content of phosphorus (P) in the coolant (S108 and S102), and if it is determined that the engine coolant has not been replaced, it is returned to changing the control temperature by increasing the opening of the integrated flow control valve 20 (S108 and S102) by the controller 30.

On the other hand, the content of phosphorus in the engine coolant shown in FIG. 3 may be predicted by subtracting the reduction amount of the phosphorus component according to the engine coolant temperature from the phosphorus content of the new coolant.

In addition, the reduction amount of the phosphorus component may be calculated by [Equation 1] when the engine coolant temperature is measured as 90° C.

Y₁=−aX₁²+bX₁, [Equation 1]

where, Y1 is the reduction amount of the phosphorus component, and X1 is the high temperature exposure time. Also, a is a constant greater than 0.0001 and less than 0.001, and b is a constant greater than 0 and less than 1.

In addition, the reduction amount of the phosphorus component may be calculated by [Equation 2] below when the engine coolant temperature is measured as 100° C.

Y₂=−cX₂²+dX₂, [Equation 2]

where, Y2 is the reduction amount of the phosphorus component, and X2 is the high temperature exposure time. Also, c is a constant greater than 0.001 and less than 0.01, and d is a constant greater than 1 and less than 2.

In addition, the reduction amount of the phosphorus component may be calculated by [Equation 3] below when the engine coolant temperature is measured as 110° C.

Y₃=−eX₃²+fX₃, [Equation 3]

where, Y3 is the phosphorus component reduction amount, and X3 is the high temperature exposure time. Also, e is a constant greater than 0.001 and less than 0.01, and f is a constant greater than 4 and less than 5.

In addition, the reduction amount of the phosphorus component may be calculated by [Equation 4] below when the engine coolant temperature is measured as 120° C.

Y₄=−gX₄⁴−hX₄³−iX₄²+jX₄, [Equation 4]

where, Y4 is the reduction amount of the phosphorus component, and X4 is the high temperature exposure time. In addition, g is a constant greater than 0.00000001 and less than 0.000001, h is a constant greater than 0.00001 and less than 0.0001, i is a constant greater than 0.001 and less than 0.01, and j is a constant greater than 5 and less than 6.

In addition, the reduction amount of the phosphorus component may be calculated by [Equation 5] below when the engine coolant temperature is measured as 130° C.

Y₅=−kX₅⁴−lX₅³−mX₅² [Equation 5]

where, Y5 is the reduction amount of the phosphorus component, and X5 is the high temperature exposure time. Also, k is a constant greater than 0.0000001 and less than 0.000001, l is a constant greater than 0.00001 and less than 0.0001, and m is a constant greater than 0.01 and less than 0.1.

As such, according to the present disclosure, the damage to the parts of the engine cooling system may be prevented in advance by managing the coolant quality through the degradation prediction of the engine coolant.

In addition, through the degradation prediction of the engine coolant, excessive maintenance is prevented and efficient coolant management is possible with an appropriate engine coolant exchange alarm.

In addition, through the degradation prediction of the engine coolant, it is possible to increase a lifespan of the engine and to strengthen commerciality and competitiveness by reducing the maintenance cost.

While this present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: engine
15: coolant line
20: integrated flow control valve
25: temperature sensor
30: controller (ECU)
40: coolant pump
50: radiator

What is claimed is:

1. A control method for an engine coolant valve, the control method comprising:
monitoring an engine driving condition and an engine driving environment;
predicting, by a controller, degradation of an engine coolant based on the engine driving condition and the engine driving environment;
changing, by the controller, an opening of an integrated flow control valve when the engine coolant is predicted to be degraded; and
generating, by the controller, a coolant exchange alarm when the engine coolant is predicted to be out of the control range and degraded.

2. The control method of the engine coolant valve of claim 1, wherein
the engine driving condition and engine driving environment include an engine coolant temperature, an engine load, and an engine intake temperature.

3. The control method of the engine coolant valve of claim 2, wherein
predicting the degradation of the engine coolant comprises:
predicting the degradation of the engine coolant by content data of phosphorus (P) in the coolant according to the engine coolant temperature and a high temperature exposure time of the engine coolant.

4. The control method of the engine coolant valve of claim 3, wherein
the engine coolant temperature is measured by a temperature sensor provided on an engine outlet.

5. The control method of the engine coolant valve of claim 3, wherein
predicting the degradation of the engine coolant comprises predicting the engine coolant to be degraded based on determining that the content of phosphorus in the coolant is less than a first value.

6. The control method of the engine coolant valve of claim 5, wherein
the content of phosphorus in the coolant is predicted by subtracting a reduction amount of the phosphorus component according to the engine coolant temperature from a phosphorus content of new coolant.

7. The control method of the engine coolant valve of claim 6, wherein
when the engine coolant temperature is 90° C., the reduction amount of the phosphorus component is calculated by the following [Equation 1]:
Y₁=−aX₁²+bX₁, [Equation 1]
where, Y1 is the reduction amount of the phosphorus component, X1 is the high temperature exposure time,
a is a constant greater than 0.0001 and less than 0.001, and b is a constant greater than 0 and less than 1.

8. The control method of the engine coolant valve of claim 6, wherein
when the engine coolant temperature is 100° C., the reduction amount of the phosphorus component is calculated by the following [Equation 2]:
Y₂=−cX₂²+dX₂, [Equation 2]
where, Y2 is the reduction amount of the phosphorus component, X2 is the high temperature exposure time,
c is a constant greater than 0.001 and less than 0.01, and d is a constant greater than 1 and less than 2.

9. The control method of the engine coolant valve of claim 6, wherein
when the engine coolant temperature is measured at 110° C., the reduction amount of the phosphorus component is calculated by the following [Equation 3]:
Y₃=−eX₃²+fX₃, [Equation 3]
where, Y3 is the reduction amount of the phosphorus component, X3 is the high temperature exposure time,
e is a constant greater than 0.001 and less than 0.01, and f is a constant greater than 4 and less than 5.

10. The control method of the engine coolant valve of claim 6, wherein
when the engine coolant temperature is 120° C., the reduction amount of the phosphorus component is calculated by the following [Equation 4]:
Y₄=−gX₄⁴−hX₄³−iX₄²+jX₄, [Equation 4]
where, Y4 is the reduction amount of the phosphorus component, X4 is the high temperature exposure time,
g is a constant greater than 0.00000001 and less than 0.000001, h is a constant greater than 0.00001 and less than 0.0001, i is a constant greater than 0.001 and less than 0.01, and j is a constant greater than 5 and less than 6.

11. The control method of the engine coolant valve of claim 6, wherein
when the engine coolant temperature is measured at 130° C., the reduction amount of the phosphorus component is calculated by the following [Equation 5]:
Y₅=−kX₅⁴−lX₅³−mX₅², [Equation 5]
where, Y5 is the reduction amount of the phosphorus component, X5 is the high temperature exposure time,
k is a constant greater than 0.0000001 and less than 0.000001, l is a constant greater than 0.00001 and less than 0.0001, and m is a constant greater than 0.01 and less than 0.1.

12. The control method of the engine coolant valve of claim 1, wherein
changing the opening of the integrated flow control valve includes increasing the opening of the integrated flow control valve to lower the temperature of the coolant.

13. The control method of the engine coolant valve of claim 1, wherein
in generating the coolant exchange alarm,
when the content of phosphorus in the coolant is predicted to be smaller than a second value, it is predicted that the engine coolant is out of a control range and degraded, and the coolant exchange alarm is generated.
